(19) United States
(12) Patent Application Publication
(10) Pub. No.: US 2007/0057612 A1
(43) Pub. Date: Mar. 15, 2007

(54) Flourescent lamp and flat lamp

(75) Inventors: Horng-Bin Hsu, Taipei City (TW); Yuan-Ker Lan, Hsinchu City (TW); Keh-Long Hwu, Jhongli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/368,741

(22) Filed: Mar. 6, 2006

(30) Foreign Application Priority Data
Sep. 12, 2005 (TW) 94131290

(51) Int. Cl. H01K 1/26; H01K 1/30; H01J 61/40; H01J 5/16

(52) U.S. Cl. 313/113

(57) ABSTRACT

The invention provides a fluorescent lamp comprising a transparent lamp with a closed chamber filled with gas, a pair of electrodes disposed at opposite ends of the transparent lamp; a layer of dielectric omni-directional reflector disposed on the inner walls of the chambers for substantially fully reflecting ultraviolet light, and a fluorescent layer disposed on the layer of dielectric omni-directional reflector for reacting with the ultraviolet light to form visible light. The invention further discloses a flat lamp comprising the above-mentioned dielectric omni-directional reflector.

### BACKGROUND

The invention relates in general to a fluorescent lamp and a flat lamp. In particular, the invention relates to a fluorescent lamp and a flat lamp with a layer of dielectric omni-directional reflector.

Cold cathode fluorescent lamps are a novel micro-illuminant usually applied in liquid crystal display, scanner, dashboard or picture frame because of high radiation intensity, uniform emission and formation in all kinds of shape.

FIG. 1 is a cross-section of a conventional fluorescent lamp comprising a transparent lamp with a closed chamber filled with mercury vapor, Ar, Ne or Xe. A fluorescent layer 105 is formed on the inner wall of the transparent lamp, and a pair of electrodes 103a, 103b is disposed at opposite ends of the transparent lamp. When the opposite electrodes of the transparent lamp 103a, 103b are applied with a high voltage, the gas inside the transparent lamp 101 such as Ar is ionized. Excited electrons collide with the Hg atoms to radiate ultraviolet light and visible light, and the ultraviolet light 209 reacts with the fluorescent layer 105 to radiate visible light 211. The ultraviolet light 209 cannot react with the fluorescent layer 105 completely, because part of the ultraviolet light 209 is absorbed by the inner wall of the chamber and converted into heat, or consumed when penetrating the chamber walls, thus reducing the conversion for visible light.

### SUMMARY OF THE INVENTION

The invention provides a fluorescent lamp and flat lamp, with a layer of dielectric omni-directional reflector. A dielectric omni-directional reflector is formed between a fluorescent layer and the inner wall of the lamp to reflect ultraviolet light penetrating the fluorescent layer, such that the ultraviolet light is confined within the fluorescent lamp and reflected repeatedly to fully react with the fluorescent layer and radiate visible light, thus improving conversion efficiency. In addition, the dielectric omni-directional reflector does not reflect visible light. The dielectric omni-directional reflector improves conversion and the emission efficiency, and reduces damage caused by ultraviolet light.

Accordingly, the invention provides a fluorescent lamp comprising a transparent lamp with a closed chamber filled with gas, a pair of electrodes disposed at opposite ends of the transparent lamp, a layer of dielectric omni-directional reflector disposed on the inner wall of the chamber to fully reflect ultraviolet light, and a fluorescent layer disposed on the layer of dielectric omni-directional reflector to react with the ultraviolet light to form visible light.

The invention further provides a flat lamp comprising a second substrate opposite to a first substrate, wherein at least one of substrates is a transparent substrate, at least one spacer disposed between the first and second substrates to provide a plurality of chambers filled with gas therebetween, a layer of dielectric omni-directional reflector is disposed on the inner wall of the chamber to fully reflect ultraviolet light, and a fluorescent layer disposed on the layer of dielectric omni-directional reflector to react with the ultraviolet light to form visible light.

### BRIEF DESCRIPTION OF THE DRAWINGS

The invention can be more fully understood by reading the subsequent detailed description in conjunction with the examples and references made to the accompanying drawings, wherein:

FIG. 1 is a cross-section of a conventional fluorescent lamp;

FIG. 2 is a cross-section of a fluorescent lamp with a layer of dielectric omni-directional reflector according to an embodiment of the invention; and

FIG. 3 is a cross-section of a flat lamp with a layer of dielectric omni-directional reflector according to an embodiment of the invention.

FIG. 4 is a cross-section of an omni-directional reflector according to an embodiment of the invention.

### DETAILED DESCRIPTION

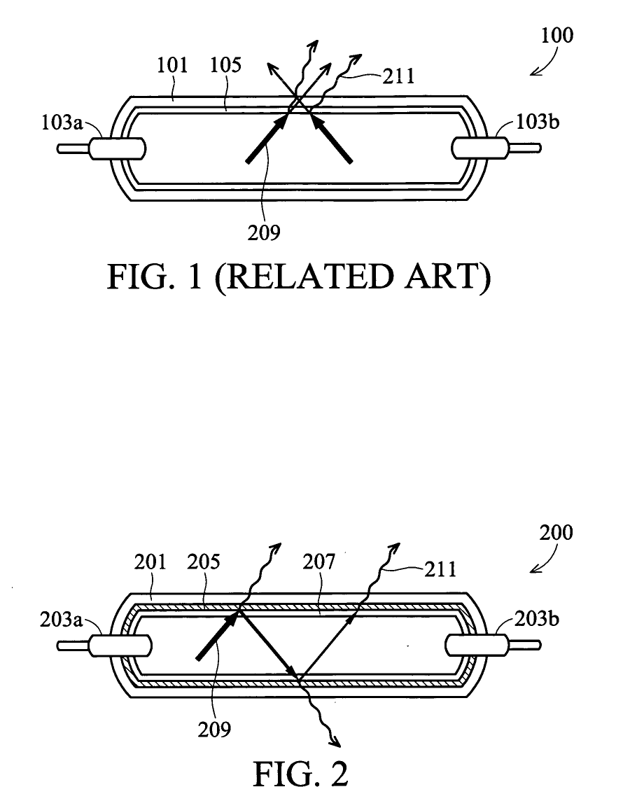

FIG. 2 is a cross-section of a fluorescent lamp with a layer of dielectric omni-directional reflector according to an embodiment of the invention. The fluorescent lamp comprises a transparent lamp 201 such as glass lamp, and a pair of electrodes 203a, 203b disposed at opposite ends of the lamp 201. The fluorescent lamp in FIG. 1 is a cold cathode fluorescent lamp (CCFL), wherein the electrodes are located inside the lamp, and or alternatively located outside the lamp such as an external electrode fluorescent lamp (EEFL). A layer of dielectric omni-directional reflector 205 and a layer which can react with the ultraviolet light to radiate visible light, such as fluorescent layer 207, are disposed on the inner wall of the fluorescent lamp 200, wherein the dielectric omni-direction layer 205 is disposed between the fluorescent layer 207 and the inner wall of the fluorescent lamp 200.

The dielectric omni-directional reflector has a periodic stacked structure, transparent in the range of visible light wavelength. The energy gap in the periodic stacked structure may filter the incident light allowing light of predetermined wavelength to pass. The bandwidth of the energy gap and corresponding frequency thereof may be adjusted by different dielectric materials and stacking periods. It is noted that one-dimension periodic structures may be provided with omni-directional energy gap with appropriate dielectric materials and stacked periods thereof. In other words, the modes of electromagnetic wave toward the periodic stacked structure from all directions cannot extend in a predetermined range of frequencies. The approximate equation of the energy gap is as follows:

$$\frac{Δω}{2 c} = \frac{α cos ( - \sqrt{\frac{A - 2}{A + 2}} )}{{d}_{1} {n}_{1} + {d}_{2} {n}_{2}} - \frac{α cos ( - \sqrt{\frac{B - 2}{B + 2}} )}{{d}_{1} \sqrt{{n}_{1}^{2} - 1} + {d}_{2} \sqrt{{n}_{2}^{2} - 1}}$$

Wherein n1, n2 are reflective coefficients of dielectric material,
d1 and d2 are thicknesses of the dielectric material,
c is the velocity of light,
ω is angle frequency, and
α is period.
Constants A and B are defined by:

$$A ≡ \frac{{n}_{2}}{{n}_{1}} + \frac{{n}_{1}}{{n}_{2}} , B ≡ \frac{{n}_{2} \sqrt{{n}_{1}^{2} - 1}}{{n}_{1} \sqrt{{n}_{2}^{2} - 1}} + \frac{{n}_{1} \sqrt{{n}_{2}^{2} - 1}}{{n}_{2} \sqrt{{n}_{1}^{2} - 1}} .$$

For a predetermined ratio d₁/a, normalized energy gaps (ω₂−ω₁/0.5(ω₂+ω₁)) can be adjusted by reflective coefficient ratios of different materials. Normalized energy gaps increase with the difference between reflective coefficients increase in each layers.

The dielectric omni-directional reflector, transparent in the range of visible light wavelength comprises, at least two of SiO₂, AlN, ZnO, Al₂O₃, Ta₂O₃ and TiO₂, with SiO₂ and Al₂O₃ are preferred. As shown in FIG. 4, The dielectric omni-directional reflector has a periodic stacked structure, including alternating layers 401 and 403 of two materials with large index contrast. The layer 401 and 403 may be SiO₂ and Al₂O₃, which display a large enough index of refraction contrast to ensure a strong reflection at a large incidence angle. The dielectric stacked structure acts as a perfect mirror due to high omni-directional reflection regardless of polarization and incident angles. The layer of dielectric omni-directional reflector may be produced by nanotechnology such as self assembly, sol-gel, or other conventional optical deposition methods such as sputtering, E-gun, or CVD (chemical vapor deposition). The dielectric omni-directional reflector exhibits high reflectivity for light in a predetermined range of wavelength regardless of incident angles and polarization thereof. Using the periodic stacked structure consisting of SiO₂ and Al₂O₃ as an example, the dielectric omni-directional reflector exhibits a reflectivity exceeding 95% for light in a predetermined range of wavelength regardless of incident angles and polarization.

The dielectric omni-directional reflector generally comprises a host compound and a dopant activator, the host compound comprising sulfate, halogen-containing phosphate, phosphate, tungstate, silicate or inorganic fluorescent material, and the inorganic fluorescent material comprising Y₂O₃, YVO₄, SrB₄O₇F, MgGa₂O₄, or combinations thereof, and the dopant activator comprising Mn, Cu, Hg, rare earth elements or transition metals of lanthanides. The dopant activator is a substitutional or interstitial material to adjust the wavelength of light radiated from the host compound. The color of the light is determined by the dopant activator such as rare-earth elements.

The chamber of the fluorescent lamp is filled with gas such as inert gas or a combination of mercury vapors and the inert gas. The fluorescent lamp uses electricity to excite inert gas or combination of inert gas and mercury vapor to produce visible light and ultraviolet light. The ultraviolet light reacts with the fluorescent layer 207 to radiate visible light, but a part of the ultraviolet light passes through the fluorescent layer 207 without reacting with the fluorescent layer 207. The dielectric omni-directional reflector 205 of the invention disposed between the fluorescent layer 207 and the transparent lamp 201 reflects the ultraviolet light, thus improving radiation efficiency and reducing the damage from ultraviolet light.

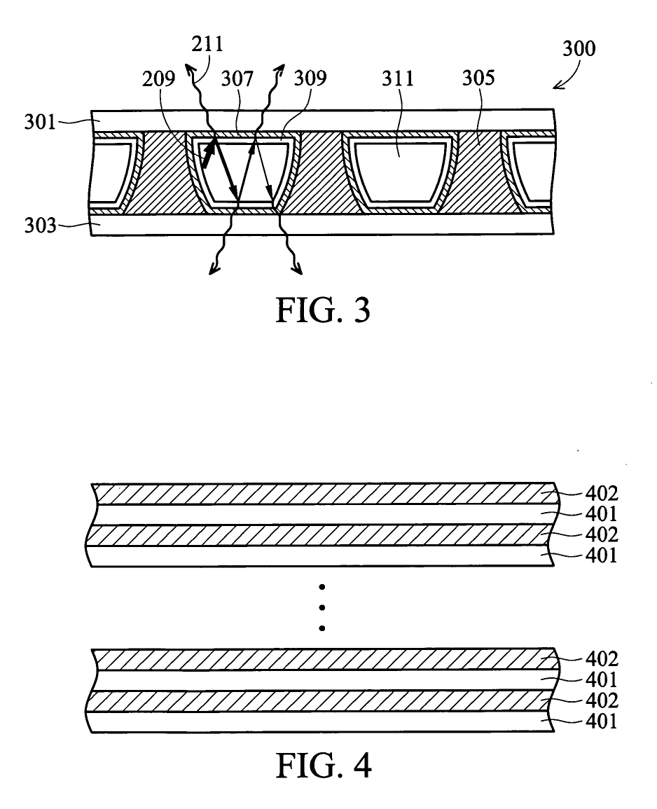

FIG. 3 is a cross-section of a flat lamp 300 according to the invention. The flat lamp 300 comprises a first substrate 301 and a second substrate 303 opposite thereto, wherein at least one of the substrates is a transparent substrate such as glass or transparent plastic. The first substrate 301 is made of glass or transparent plastic, and the second substrate 303 is made of glass or transparent plastic. The first and second substrates 301, 303 may be the same or different. A plurality of spacers 305 are disposed between the first substrate 301 and second substrates 303 to provide a plurality of chambers 311 therebetween. Although the chambers 311 illustrated in FIG. 1 are isolated, the chambers may connect to each other, and the spacers 305 may be isolated between the first and second substrates 301, 303 or integral with the first or second substrates 301, 303. The spacers 305 may be in the form of a stick, a plurality of columns or a crisscross.

The chamber 311 is filled with gas such as inert gas or a combination of mercury vapor and an inert gas. A fluorescent layer 309 and a layer of dielectric omni-directional reflector 307 are disposed on the inner wall of the chamber 311, wherein the layer of dielectric omni-directional reflector 307 is disposed between the fluorescent layer 309 and the inner wall of the chamber 311. The dielectric omni-directional reflector is a periodic stacked reflector comprising at least two of SiO₂, AlN, ZnO, Al₂O₃, Ta₂O₃ and TiO₂, with SiO₂ and Al₂O₃ preferred. The layer of dielectric omni-directional reflector 307 may be formed by self-assembly, sol-gel or other optical deposition methods such as sputtering, E-gun or CVD (chemical vapor deposition). The dielectric omni-directional reflector may substantially fully reflect lights in a predetermined range of wavelength regardless of polarization. Using the periodic stacked structure consisting of SiO₂ and Al₂O₃ as an example, the reflectivity exceeds 95% for lights in a predetermined range of wavelength.

The flat lamp 300 uses electricity to excite inert gas or a combination of the inert gas and mercury vapors therein to produce visible light and ultraviolet light 209. The ultraviolet light 209 then reacts with the fluorescent layer 309 to radiate visible light 211, however, a part of the ultraviolet light 209 passes through the fluorescent layer 309 without reacting with the fluorescent layer 309. The layer of dielectric omni-directional reflector 307 of the invention allows the visible light to pass, and reflects ultraviolet light which has passed the fluorescent layer 309, improving radiation efficiency and reducing the damage from ultraviolet light.

Finally, while the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A fluorescent lamp, comprising:
a transparent lamp with a closed chamber filled with gas;
a pair of electrodes disposed at opposite ends of the transparent lamp;
a layer of dielectric omni-directional reflector, disposed on an inner wall of the transparent lamp, adapted to substantially fully reflect ultraviolet light; and
a layer, disposed on the layer of dielectric omni-directional reflector, adapted to react with the ultraviolet light to radiate visible light.

2. The fluorescent lamp of claim 1, wherein the layer of dielectric omni-directional reflector is configured to substantially fully reflect ultraviolet light in all polarizations.

3. The fluorescent lamp of claim 1, wherein the electrodes are disposed inside the transparent lamp.

4. The fluorescent lamp of claim 1, wherein the electrodes are disposed outside the transparent lamp.

5. The fluorescent lamp of claim 1, wherein the layer of dielectric omni-directional reflector is a transparent, periodic stacked multilayer structure.

6. The fluorescent lamp of claim 1, wherein the layer of dielectric omni-directional reflector is a periodic stacked structure comprising at least two of SiO₂, AlN, ZnO, Al₂O₃, Ta₂O₃ and TiO₂.

7. The fluorescent lamp of claim 1, wherein the layer of dielectric omni-directional reflector is a periodic stacked structure consisting of SiO₂ and Al₂O₃.

8. The fluorescent lamp of claim 1, wherein the layer of dielectric omni-directional reflector for ultraviolet light has a reflectivity greater than about 95%.

9. The fluorescent lamp of claim 1, wherein the host compound comprises sulfate, halogen-containing phosphate, phosphate, tungstate, silicate, or inorganic fluorescent materials.

10. The fluorescent lamp of claim 1, wherein the dopant activator comprises Mn, Cu, Hg, a rare earth elements, or a transition metal.

11. A flat lamp, comprising:
a first substrate;
a second substrate opposite to the first substrate, wherein at least one of the first and second substrates is a transparent substrate;
at least one spacer disposed between the first and second substrates, thereby forming a plurality of chambers filled with gas therebetween;
a layer of dielectric omni-directional reflector, disposed on the inner walls of the chambers, adapted to substantially fully reflecting ultraviolet light; and
a layer, disposed on the layer of dielectric omni-directional reflector, adapted to react with the ultraviolet light to form visible light.

12. The flat lamp of claim 11, wherein the layer of dielectric omni-directional reflector is configured to substantially fully reflect ultraviolet light in all polarizations.

13. The flat lamp of claim 11, wherein the spacer and the first substrate are integrally formed.

14. The flat lamp of claim 11, wherein the spacer and the second substrate are integrally formed.

15. The flat lamp of claim 11, wherein the spacer is in the form of a stick, a plurality of columns, or a crisscross.

16. The flat lamp of claim 11, wherein the layer of dielectric omni-directional reflector is a transparent, periodic stacked multilayer structure.

17. The flat lamp of claim 11, wherein the layer of dielectric omni-directional reflector is a periodic stacked structure comprising at least two of SiO₂, AlN, ZnO, Al₂O₃, Ta₂O₃, and TiO₂.

18. The flat lamp of claim 11, wherein the layer of dielectric omni-directional reflector is a periodic stacked structure consisting of SiO₂ and Al₂O₃.

19. The fluorescent lamp of claim 11, wherein the layer of dielectric omni-directional reflector to ultraviolet light has a reflectivity greater than about 95%.

20. The flat lamp of claim 11, wherein the host compound comprises sulfate, halogen-containing phosphate, phosphate, tungstate, silicate, or inorganic fluorescent materials.

21. The flat lamp of claim 11, wherein the dopant activator comprises Mn, Cu, Hg, a rare earth element, or a transition metal of lanthanides.
